(19) United States
(12) Patent Application Publication
(10) Pub. No.: US 2015/0180981 A1
(43) Pub. Date: Jun. 25, 2015

(54) Communications Server Apparatus, Calling Device And Methods Of Operation Thereof

(71) Applicant: GLOBALROAM PTE LTD., Singapore (SG)

(72) Inventors: Clarence Tan, Singapore (SG); Hari Krishna Garg, Singapore (SG); Abdul Qadir, Singapore (SG); Zhiyong Han, Singapore (SG)

(21) Appl. No.: 14/420,008

(22) PCT Filed: Aug. 6, 2013
(86) PCT No.: PCT/SG2013/000332

§ 371 Date: Feb. 6, 2015

Related U.S. Application Data
(60) Provisional application No. 61/742,244, filed on Aug. 6, 2012.

(30) Foreign Application Priority Data
Aug. 7, 2012 (SG) 201205921-8

(51) Int. Cl. H04L 29/08

(52) U.S. Cl. CPC H04L 67/141; H04L 67/02

(57) ABSTRACT

A communications server apparatus (102) comprises a processor (116) and a memory (118), and is configured, under control of the processor, to execute instructions (120) stored in the memory to receive, over a communications link (108, 110, 112), URL information relating to a caller input at a calling device (104), the caller input being selection or activation of a URL as a request for a communication session with a recipient device (106a, 106b). The recipient device is identified using the URL information and a communication session is initiated between the calling device and the recipient device. The calling device implements complementary functionality to interface with the communications server apparatus.

The invention relates to a communications server apparatus for initiating a communication session between a calling device and a recipient device. The invention also relates to a calling device for communicating with a recipient device through a communications server apparatus. The invention also relates to corresponding methods of operation and a computer readable medium having stored thereon computer-readable instructions for executing one or more of the methods.

The invention has particular, but not exclusive, application in the initiation of a “one-click” communication service from a calling device to a recipient device. In at least some implementations, communications sessions may be conducted through a web browser of the calling device for user convenience.

Recent significant increases in Internet connectivity and bandwidth capabilities have led to a flurry of activity in attempts to take advantage of these technological advances. Numerous Voice over Internet protocol (VoIP) techniques have thus been developed in an effort to provide users with convenient and cost effective techniques for communications such as a voice and/or video calls.

Many efforts have resulted in development of software applications of varying types being made available for users to download and use at their computing devices (e.g. desktop or laptop computer, PDA, tablet, smart phone etc.), perhaps the most popular of which has been Skype (TM).

U.S. Pat. No. 7,593,355 discloses techniques for providing an interface to a caller during the initiation of a VoIP call. This includes placing, by the caller, a request for information regarding a party to be called; returning a URL responsive to the request; and displaying to the caller one or more connection options corresponding to the URL, where selection of one of the connection options initiates a SIP request to make the connection.

International Patent Publication No. WO 2006/010193 discloses a system in which computers commencing a VoIP call over a communication network download a small control program from an initiator system. The control program configures the use of equipment for voice or video communication on each caller computer and enables a direct peer-to-peer connection between the computers. Each of the calling and called parties receives an invitation to join the call, the invitation including a URL or hyperlink that the user follows to initiate their part of the call. Once each of the users follows the link, they are patched through to the initiator system which bridges the call.

United States Patent Application No. 2006/0210041 is directed to a third-party call control application program interface which permits users to use a web browser or other Internet capable software to place a call. A user initiates the call and then a SIP proxy server sets up a call between a “from” telephone and a “to” telephone.

Other, exemplary techniques are described in U.S. Pat. No. 7,493,381, Korean Patent Publication No. 10-2007-0078543, Korean Patent Publication No. 2002-0088977 and Japanese Patent Publication No. 2002-305588, to name but a few.

The invention is defined in the independent claims. Some optional features of the invention are defined in the dependent claims.

Implementation of the techniques disclosed herein may permit users to take advantage of significant technical benefits, including the fact that it may not be necessary for a calling user to download a software application for use at the user's calling (e.g. computing) device. Thus, and for example, a user need not go to the bother of downloading and installing a software application on his or her computing device. Furthermore, some computing users view the need to download executable software applications as undesirable because, for example, these may impose a drain on the resources of the computing device; such concerns may thus be obviated. Further, this may also obviate the problem that there is a still a school of thought that downloadable software applications are to be viewed, generally, suspiciously, for fear of downloading nuisance (e.g. add-on programs like browser toolbars which initiate multiple pop-up advertisements) or malicious (viruses, Trojans etc.) software appended to or hidden within the software application.

In at least some implementations, the techniques disclosed herein may provide for true “one-click” calling, requiring only, for example, selection or activation of a URL (uniform resource locator) at the calling device for a communication session to be set up between the calling device and the recipient device. After selection or activation of the URL, all necessary procedures and communications system transactions for setting up the communication session may be automatically executed.

Selection or activation of a URL can be effected by any one of a number of ways. For example, a user may click (i.e. select) a hyperlink pointing at a web resource defined by the URL, thereby to “select” the URL. Of course, the hyperlink may be presented to the user any webpage, e-mail message, SMS, etc. by way of invitation for the callee to be called, and any person wishing to contact the callee may simply select or activate the URL accordingly. Additionally or alternatively, the user can simply type the URL characters into, say, the address bar of a web browser on the user's computing device and activate the URL by, for example, pressing “ENTER” on a keyboard of the computing device. Internet—for example, Google—searches for the URL may also be sufficient. In another example, the user can select or activate the URL by reading a graphic, such as a QR code, the graphic directing the user's computer device to the web resource defined by the URL.

As described in greater detail below, a communications server apparatus may receive information relating to a caller input (the selection or activation of the URL) at the calling party's computing device. Thus, the communications server apparatus may receive information relating to the URL. In one form, the communications server apparatus may receive the URL itself. The communications server apparatus may identify the party to be called—the recipient device—from the URL information and may initiate the communication session between the calling device and the recipient device. In one form, the URL may include, for example, the telephone number of the intended call recipient, or information relating thereto which allows the communications server apparatus to identify or retrieve the telephone number, and/or otherwise identify the callee. The communications server apparatus may extract the telephone number from the URL and/or identify the calling device from, say, a database (e.g., with reference to a look up table in the database) and initiate the communication session between the calling device and the recipient device.

Implementation of these techniques may be particularly advantageous when the URL is defined by the call recipient. Thus, and for example, an alias can be used by the callee—the user of the recipient device—in order that the telephone number of the recipient device (which the callee might not want to publicise), need not be given out or otherwise publicised in order for people to call the callee using the techniques disclosed herein.

None of the prior art documents cited above disclose or suggest a technique in which a user at a calling device selects/activate a URL at the calling device thereby to initiate a communications session between the calling device and a recipient device, where the recipient device is identifiable from information relating thereto, or the URL itself.

Thus the techniques disclosed herein, and as will be described in further detail below, may allow a user to make a voice/video call (or conference call, send SMS, voice-mail, fax, email etc.) to a calling device—including telephones (and mobile telephones) and other computing devices such as smart phones, PDAs and tablets—from a provider's web-site in a one click manner when the user is navigating/browsing the Internet using a standard web-browser such as Internet Explorer, Chrome, Firefox, and Safari or mobile/tablet web browsers on his or her computing device. The electronic address (phone number, IP address, or other addresses such as email, IM, on-line accounts etc.) to be called or its equivalent code may be placed right in the URL, or derivable therefrom, making it a one-click way to establish a session for data communication, such as by making a call to a phone and/or a computer. It includes providing the same functionality to the caller via a URL link to the provider's web-site on another web-site (or in emails, social networking sites, SMS, IM Chat etc.) that the caller may click to make the call. It may be that the caller does not need to download any software or carry out any software/system configuration. The call may be established between caller's computer via the provider's page that the caller is browsing and the callee's phone number (or its equivalent code) in the URL. Further, since a link/URL may be used to establish the call (voice/video), the history of the call can be managed easily from the information contained in the history folder(s) of the web-browser.

The “one-click” way of making a call by entering the URL in the web-browser or clicking a link to it can be further used to provide for additional features and functionalities such as caller-ID, call recording, private number calling, on-line access to call records, voice-mail, call-back etc. The URL to call or equivalently the link to the URL to call can be generated either by (i) the caller or (ii) the callee (recipient of the phone call), or (iii) a third party; working on their own or in collaboration. As will be seen below, it may be particularly beneficial if the callee defines the URL his or herself. These techniques provide the callers/callees/third parties with the facility to create the links for the desired features/functionalities of the call. Such a link/URL/QR code may be the same for all callers or different and customized for each caller or a group of callers.

As used herein, the terms call, voice call, video call, voice/video call etc. are used in an interchangeable manner throughout this document. Further, QR codes (in conjunction with URLs and/or links) may be used to establish calls when scanned appropriately.

There are numerous VoIP services where the callers have to download a software application and undertake system/software configuration on their computers.

As used herein, the term “computer” or the term “computing device” may be considered to be a device that can provide for connectivity to the internet. Thus, a computer can be a PC, laptop, netbook, mobile phone, smart phone, IP phone, gaming device, set-top box, iPAD, tablet PC and other such equivalent devices as any of these can be used to access the web for accessing web-sites as well as making calls using VoIP and other technologies. Typically, a computer uses LAN, routers, WLAN, DSL, cable, 3G, LTE, WiMAX, 3G+ etc. for data communication required to access the internet. A computer typically accesses the web and its contents, services and applications via an Internet browser, instances of which include Internet Explorer, Firefox etc.

Existing services for making VoIP calls (Google, MSN, Yahoo etc.) from a caller's computer require the caller to come to the provider's web-site, have an on-line account, enter the phone number in a box, and then press call. This requires many steps and may be cumbersome to the caller. Other services (including Skype, Google, etc.) require the callers to download software and configure it on their computer.

As used here, the term “phone” can be considered to be a land line (or fixed line) phone, cellular/mobile phone, smart phone, IP phone, a Wi-Fi phone etc. It may be considered to be a device that can be used for making/receiving a call via an electronic address consisting primarily of numeric strings or a phone number.

Certain special characters such as “+” may also be used for the phone number representations.

The invention will now be described, by way of example only, and with reference to the accompanying drawings in which:

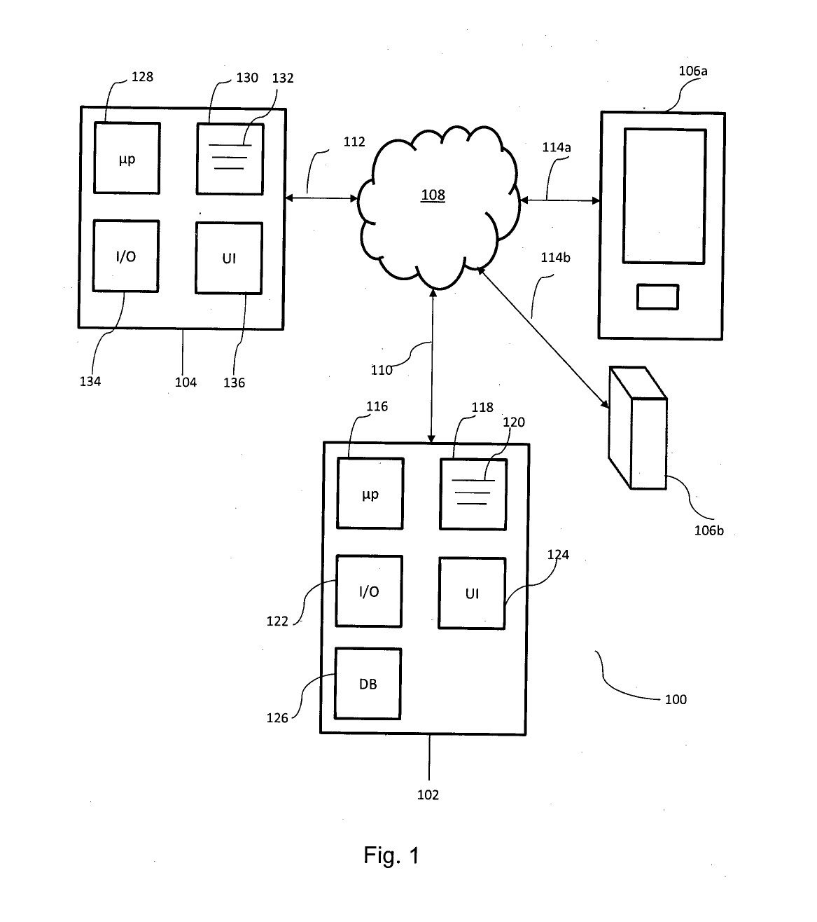

FIG. 1 is a schematic block diagram illustrating a system for enabling communication between a calling device and the recipient device;

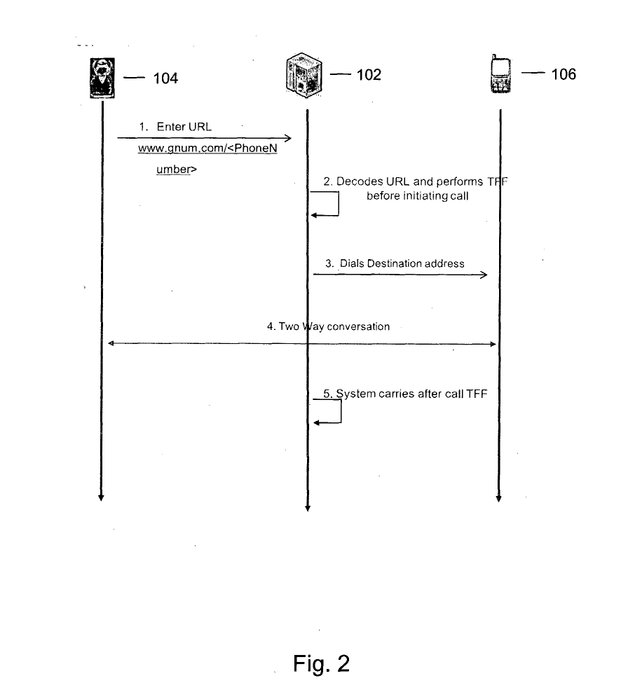

FIG. 2 is a first call timing diagram illustrating a sequence of events for a first communications technique;

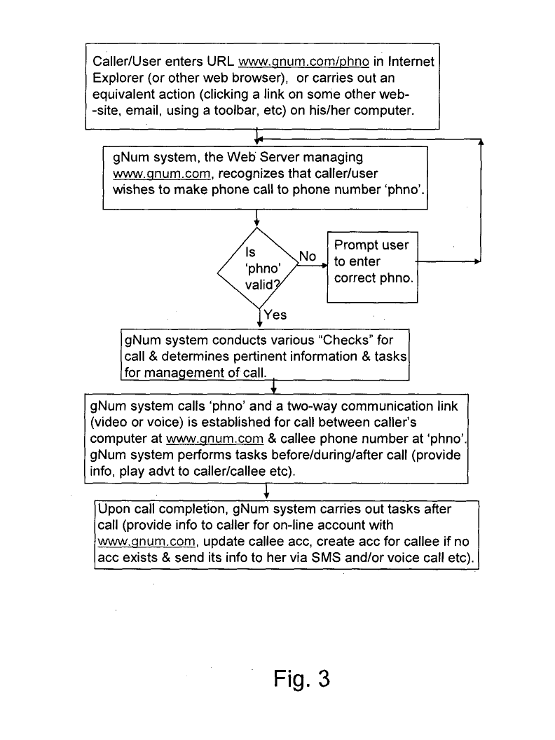

FIG. 3 is a first flow diagram illustrating an algorithm flow for another communications technique;

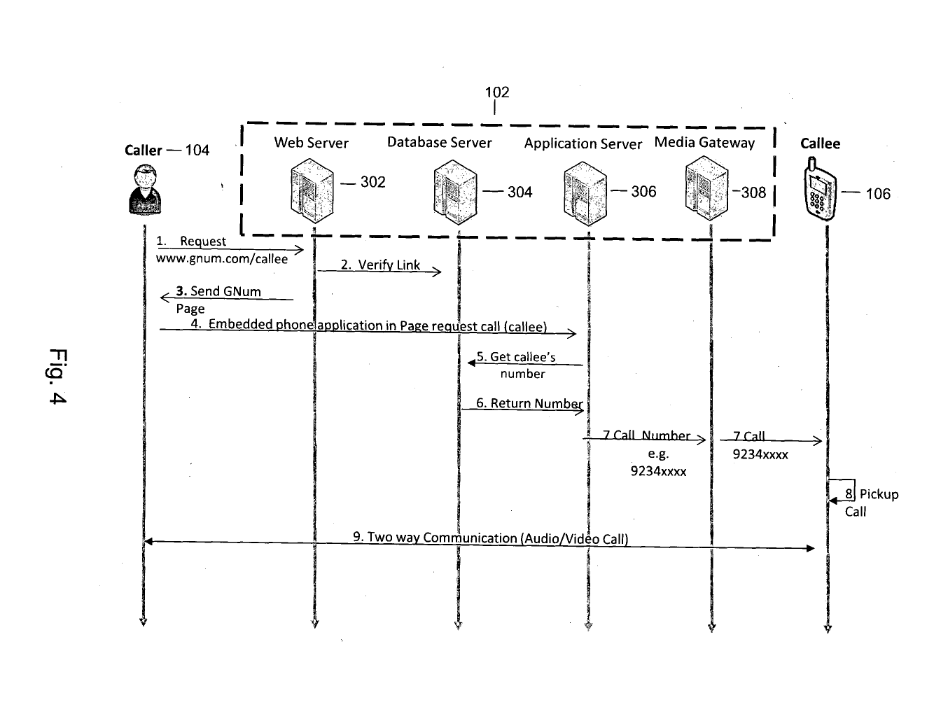

FIG. 4 is a second call timing diagram illustrating a sequence of events for another communications technique;

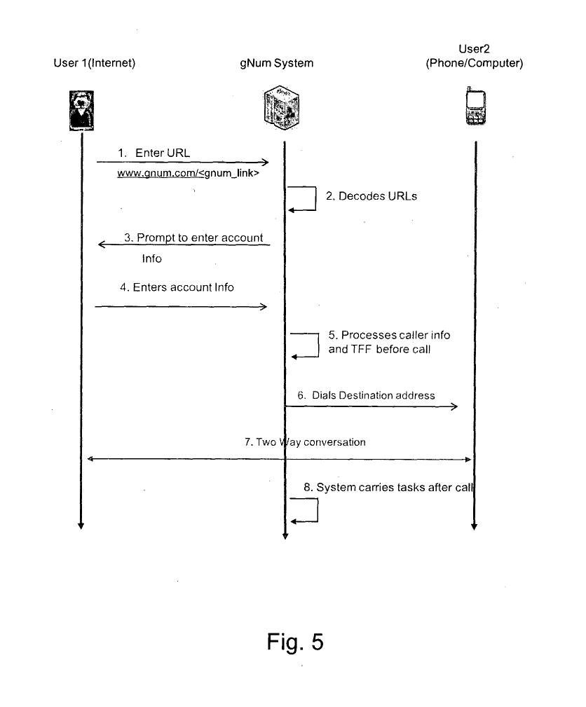

FIG. 5 is a third call timing diagram illustrating a sequence of events for another communications technique;

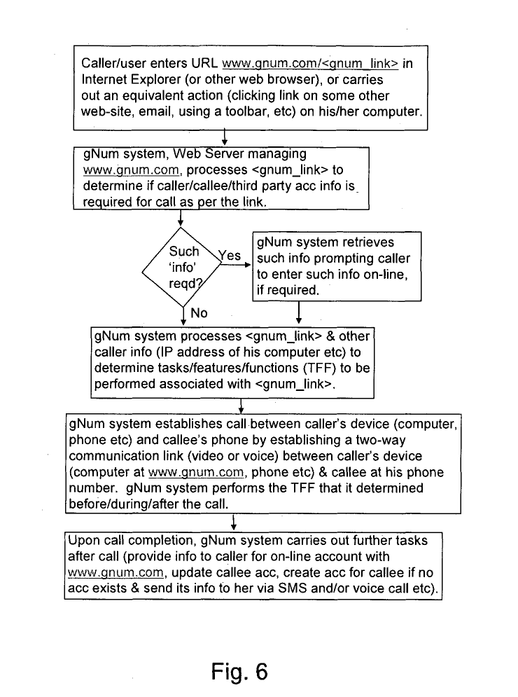

FIG. 6 is a second flow diagram illustrating an algorithm flow for another communications technique;

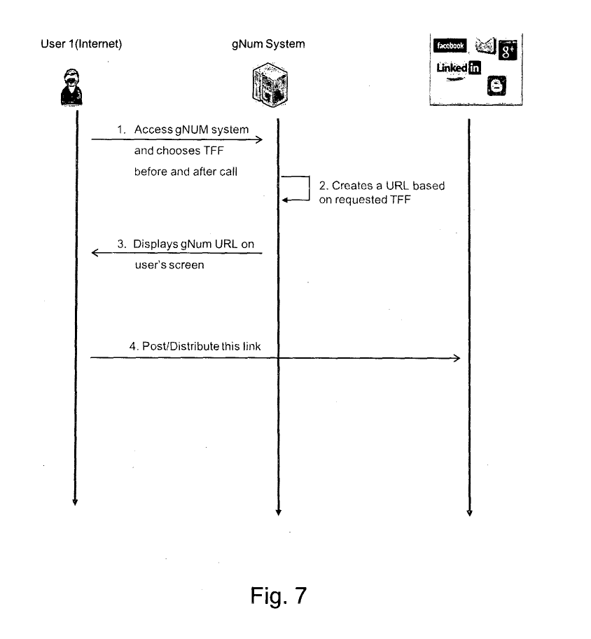

FIG. 7 is a third call timing diagram illustrating a sequence of events for another communications technique;

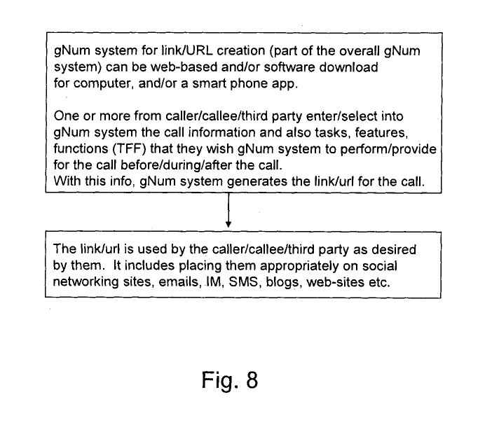

FIG. 8 is a third flow diagram illustrating an algorithm flow for another communications technique;

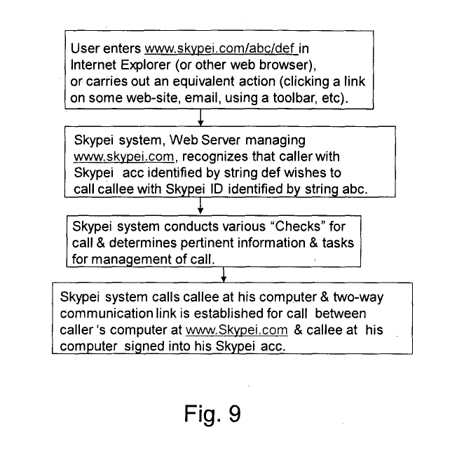

FIG. 9 is a fourth flow diagram illustrating an algorithm flow for another communications technique;

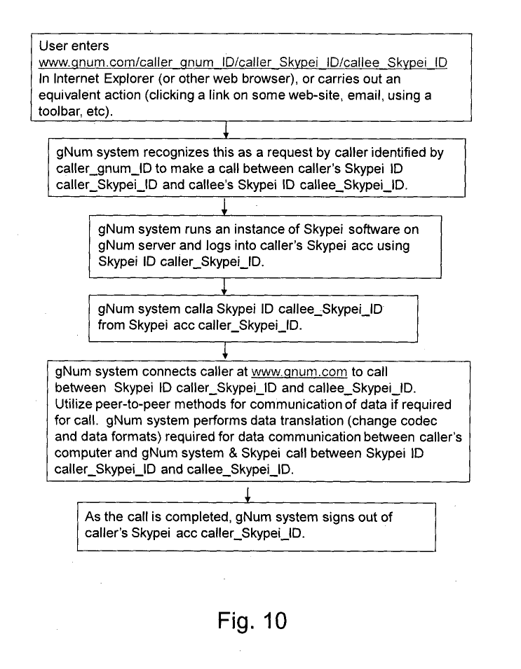

FIG. 10 is a fifth flow diagram illustrating an algorithm flow for another communications technique;

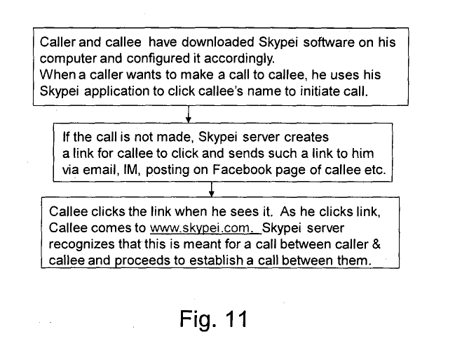

FIG. 11 is a sixth flow diagram illustrating an algorithm flow for another communications technique;

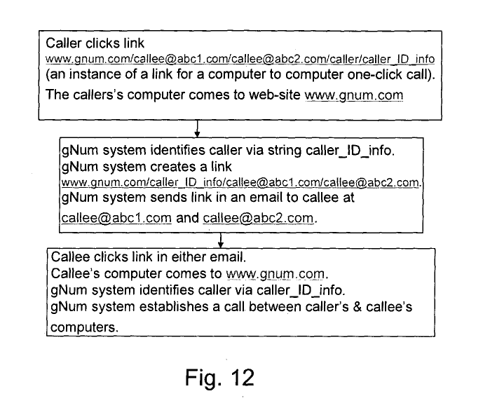

FIG. 12 is a seventh flow diagram illustrating an algorithm flow for another communications technique;

Referring first to FIG. 1, a communications system 100 is illustrated. Communications system 100 comprises communications server apparatus 102, calling device 104 and recipient devices 106a, 106b. These devices are connected in the communications network 108 (for example the Internet) through respective communications links 110, 112, 114a/114b. Recipient devices 106a, 106b may be able to communicate through other communications network, such as public switched telephone networks (PSTN networks), including mobile cellular communications networks, but these are omitted from FIG. 1 for the sake of clarity.

Communications server apparatus 102 may be a single server as illustrated schematically in FIG. 1, or have the functionality performed by the server apparatus 102 distributed across multiple server components. One such arrangement is illustrated in FIG. 4, to be discussed in further detail below. In the example of FIG. 1, communications server apparatus 102 may comprise a number of individual components including, but not limited to, microprocessor 116, a memory 118 (e.g. a volatile memory such as a RAM) for the loading of executable instructions 120, the executable instructions defining the functionality the server apparatus 102 carries out under control of the processor 116. Communications server apparatus 102 also comprises an input/output module 122 allowing the server to communicate over the communications network 108. User interface 124 is provided for user control and may comprise, for example, conventional computing peripheral devices such as display monitors, computer keyboards and the like. Server apparatus 102 may also comprises a database 126, the purpose of which will become_readily apparent from the following discussion.

Calling device 104 may comprise a number of individual components including, but not limited to, microprocessor 128, a memory 130 (e.g. a volatile memory such as a RAM) for the loading of executable instructions 132, the executable instructions defining the functionality the calling device 104 carries out under control of the processor 128. Calling device 104 also comprises an input/output module 134 allowing the calling device 104 to communicate over the communications network 108. User interface 136 is provided for user control. This may take the form of, for example, conventional computing peripheral devices such as display monitors, computer keyboards and the like. Alternatively, if the calling device 104 is, say, a smart phone or tablet device, the user interface 136 being in the form of a touch panel display as is prevalent in many smart phone and other handheld devices.

Recipient devices 106a, 106b may be, for example, telephones such as device 106a or say, conventional computing devices 106b, or other services such as voicemail services as described below.

FIG. 2 illustrates a first timing sequence for the flow of information in the initiation of a communication session between the calling device 104 and the recipient device 106. At sequence step 1, the calling user at calling device 104 select, activates or otherwise enters a URL as described above at the calling device 104. As illustrated in FIG. 2, this URL takes the form of www.gnum.com/<PhoneNumber>, where gnum is a trademark of the applicant and gnum.com is a domain registered to the applicant. Calling device 104 transmits, to the communications server apparatus 102, URL information relating to the caller input. As noted above, this URL information may include the URL itself. Communications server apparatus 102 identifies the recipient device using the URL information, for example decoding the URL to obtain the telephone number or otherwise extracting the telephone number therefrom. In at least one technique, this is implemented by reference to database 126 which retains a record of at least the recipient device, and information allowing the recipient device to be identified from the URL information.

Communications server apparatus may also determine other tasks, features and functions (TFF) to be performed—such as the playing of messages, including advertisement messages—before initiating the call at sequence step 2, before initiating the call to the recipient device 106 at sequence step 3. (Additionally or alternatively, the playing of messages may be performed during and/or after the call, although it might be preferable if these are graphical messages only if played during the call.) Once the user of recipient device picks up the call, two-way communication, for example two-way conversation, will take place at sequence step 4.

Thus it will be appreciated that FIG. 1 and FIG. 2 illustrate a communications server apparatus 102 comprising a processor 116 and a memory 118, the communications server apparatus 102 being configured, under control of the processor 116, to execute instructions 120 stored in the memory 118: to receive, over a communications link 108, 110, 112, URL information relating to a caller input at a calling device 104, the caller input being selection or activation of a URL as a request for a communication session with a recipient device 106a, 106b; to identify the recipient device 106a, 106b using the URL information; and to initiate the communication session between the calling device 104 and the recipient device 106.

Alternatively, it will be appreciated that there is illustrated a method, performed in a communications server apparatus 102, the method comprising, under control of a processor 116 of the communications server apparatus: receiving, over a communications link 108, 110, 112, URL information relating to a caller input at a calling device 104, the caller input being selection or activation of a URL as a request for a communication session with a recipient device 106; identifying the recipient device 106 using the URL information; and initiating the communication session between the calling device 104 and the recipient device 106.

It will also be appreciated that FIG. 1 and FIG. 2 illustrate a calling device 104 comprising a processor 128 and a memory 130, the calling device 104 being configured, under control of the processor 128, to execute instructions 132 stored in the memory 130: to receive a caller input, the caller input being selection or activation of a URL as a request for a communication session with a recipient device 106; to transmit, over a communications link 108, 110, 112, URL information relating to the caller input to a communications server apparatus 102, for allowing the communications server apparatus 102 to identify the recipient device 106 using the URL information; and to communicate, over the communications link, with the recipient device responsive to the communications session being initiated by the communications server apparatus 102.

Alternatively, it will be appreciated that there is illustrated a method performed in a calling device 104, the method comprising, under control of a processor of the calling device 104: receiving a caller input, the caller input being selection or activation of a URL as a request for a communication session with a recipient device 106a, 106b; transmitting, over a communications link, URL information relating to the caller input to a communications server apparatus, for allowing the communications server apparatus to identify the recipient device using the URL information; and communicating, over the communications link, with the recipient device responsive to the communications session being initiated by the communications server apparatus

Thus, the techniques disclosed herein allow use of a website to make a call to, for example, a telephone. In this example, the website www.gnum.com is used as the web-site for the call. Please note that it is not necessary that a unique website is maintained at the web server gnum.com for each and every calling device that may be called using the service. It may be that all that is necessary is for the calling party to be directed to the gnum.com website, and thereafter the communications server apparatus 102 extracts or otherwise identifies the recipient device from the URL, sufficient for a call to be placed thereto.

Anyone who wishes to make a call (voice or video) to a phone number (+659661xxxx) can enter the following URL in the web-browser (we use Internet Explorer without any loss of generality) of his computer:

www.gnum.com/+659661xxxx.

Alternatively the caller can click a link www.gnum.com/+659661xxxx on some other website to get to the web-site www.gnum.com to make a call to +659661xxxx. This link may also be provided in emails, social networking postings, blogs, and IM chat logs or other places such as print media, bill-boards, newspapers etc. Equivalently, QR codes may be utilized for the same purpose.

It is also possible to enter this URL in a toolbar or the search box of Google (or some other search engine).

The server 102 for the web-site www.gnum.com, (which may be referred to as the gNum system), now processes the URL and recognizes that the user/caller wishes to make a phone (voice or video) call (in general establish a session for communication for exchange of certain types of data/information) to the phone number +659661xxxx. The gNum system may also track the referring web-site the caller clicked the link at for various purposes including payments, user-profiling, advertising etc. Further, the gNum system may determine and use the IP address of the caller's computer to determine how exactly it needs to process the link clicked by the caller. It now carries out “Checks” before making the phone call. A non-exhaustive list of such checks is:

1. Is +659661xxxx a valid phone number? If not prompt the user to enter the correct phone number. Is this a mobile number or a land-line number?

2. Can this call be made and how? This includes things like who will pay for the call and pricing information, which if any advertisements/information (which could be based on the URL and other related information such as caller's/callee's geographic regions) be played for the caller on the web-site www.gnum.com or the callee on the phone number before/during/after the call. Can this be a video call or just a voice call?

3. How should information about this call be managed? Who will have access rights to this information and how will they access it.

4. What should happen after the call? For instance, the billing and other accounting services may be carried out. Should the caller on the web-site www.gnum.com or the callee be asked to sign up for an account with www.gnum.com for future services?

5. Does the callee already have an on-line account with www.gnum.com that can be identified via the phone number of the callee? What information, if any, about this call be made available to the callee via his/her on-line account?

Once the checks are completed and the gNum system has determined the exact way the caller request is to be processed, the call (voice or video) is established between the caller's computer that is browsing the web-site www.gnum.com and the callee with the phone number +659661xxxx via VoIP call between the caller's computer browsing the web-site www.gnum.com and the callee at the phone number +659661xxxx. The second leg of the call over the communications link 114a, 114b may be completed through, say, the PSTN network. If the recipient device is sufficiently enabled, the second leg of the call may be completed using VoIP techniques as well. After the call is completed, the gNum system at www.gnum.com may perform the remaining tasks associated with the call as determined by the gNum system. The caller may be asked to either sign-up for a new account or provide information about an existing one. Similarly, the callee may be invited to open a new account by providing a user ID and password if he/she is identified not to have an account already via a follow-up SMS and/or a call. Call information may be placed in the caller's on-line account if the caller signs into his/her account at any time. Similarly, it may be placed in the callee's account.

A flowchart for the above method of making a call from a web-site to a phone is shown in FIG. 3.

Alternatively, the URL for making the call to +659661xxxx (65 for Singapore country code and 9661xxxx as the phone number) can be

www.gnum.com/659661xxxx

and the gNum system can now intelligently figure out that the number entered corresponds to Singapore via country code 65 and phone number 9661xxxx. The caller may also be asked to indeed verify this as the gNum system makes the call to the phone number.

An alternative hardware setup for the communications server apparatus 102, and an alternative signal sequence flow is illustrated in FIG. 4. In this example, communications server apparatus 102 is composed of discrete server devices, in order to sub-divide the server functionality. Thus, communications server apparatus 102 comprises of a web server 302, a database server 304, and application server 306 and a media gateway 308. In this example, each discrete server device operates under control of its own processor (not shown) to control the device to perform the necessary functionality defined by instructions which may be loaded into the memories of each of the server devices.

In the example of FIG. 4, the user selects or activates the URL in the same way as described above. Calling device 104 then, sends URL information at sequence step 1 to web server 302. Web server 302 then receives the URL information, at sequence step 2 sending a request to database server 304 for the database server 304 to verify the link. If the link is verified, web server 302, at sequence step 3, then transmits a webpage (the “gnum page”) to the calling device 104. The gnum page/webpage has a communications application embedded therein for facilitating the communication session with the calling device 106. When the page renders in, say, a web browser of the calling device 104, voice and/or video communication may be enabled from the calling device 104. Thus, it will be appreciated, that the communications server apparatus 102 is configured, responsive to receipt of the URL information, to transmit webpage information to the calling device 104, the webpage information comprising application code for an application for channeling the communication session between the calling device 104 and the recipient device 106.

The communications application runs in the web browser, perhaps in the background. That is, communications server apparatus 102 is configured to transmit, to the calling device 104, application code for the application to run in the background of a web browser program on the calling device 104.

With the application running on calling device 104, calling device 104 then transmits a request to call the recipient device at step sequence 4 to the application server 306. That is, communications server apparatus 102 is configured to transmit, to the calling device 104, application code for causing calling device 104 to transmit an initiate call request to the communications server apparatus 102 (in this instance application server 306), the initiate called request being a request to initiate a call to the recipient device 106.

In the example of FIG. 4, application server 306 then, at sequence step 5, invokes a request to database server 304 to identify the calling device 106 from the URL. A call identifier, such as the telephone number, is returned to application 306 at sequence step 6. At sequence step 7, application server 306 places a call to the recipient device 106 through media gateway 308. Thus, communications server apparatus 102 is configured, responsive to receiving the initiate call request, to retrieve a call identifier for the recipient device using the URL information, and to initiate a call to the recipient device using the call identifier.

At sequence step 8, the recipient user of recipient device 106 picks up the call, and communication is established at sequence step 9 between calling device 104 and recipient device 106.

As mentioned above, implementation of the techniques disclosed herein may facilitate true “one-click” calling by selection or activation of a URL by a calling user of the calling device, where the URL can be used to identify the recipient device associated with a recipient user whom the calling user wishes to communicate with. After the selection/activation of the URL, all of the steps necessary to initiate the communications session may be activated automatically.

In an alternative arrangement, the URL of the link to make a call is of the format www.gnum.com/<gnum_link>.

Here, <gnum_link> has the following format:

string1/string2/ . . . /stringn.

Each of the ‘n’ strings, string1, string2, stringn, is a string of alphanumeric characters. When the caller clicks the link (or equivalently enters the URL in the web browser of his computer),

www.gnum.com/<gnum_link>,

the caller's computer comes to the web-site www.gnum.com via the computer's web browser to make a call (video/voice) having service definition determined by the gNum system via <gnum_link> and other related information about the caller (IP address of caller's computer, the web-site the link was located when it was clicked, time of day) and so on. <gnum_link> may need to be decrypted by gNum system as it may be in encrypted form to protect callers, callees and the overall gNum system. The gNum system may also determine the web-site the caller was on (if any) when he/she clicked the link and the IP address of the caller's computer when he/she comes to the web-site www.gnum.com by either entering the URL in the browser of his computer or by clicking the link. The service definition may include one or more from the following non-exhaustive list of tasks:
valid link for the call?
How will caller communicate with the gNum system for the call? If he is on-line then complete routing information for the communication from the callee phone number to the caller's computer and/or phone and vice versa is determined by gNum system.
callee phone number
caller phone number
callee phone number to be called from which gNum system phone number
callee user account with www.gnum.com
caller user account with www.gnum.com
call to be recorded or not; other features of the call?
Time and/or other restrictions when the call can be made. Instances of restrictions include caller's IP, caller's gNum account, web-site from which caller clicked the link, location of caller and so on.
Functions/tasks/features of the call as determined by the gNum system based on the IP address of the caller's computer when he/she comes to www.gnum.com
pricing/costing info
Things to be done before, during, after the call, for instance advertisements or other messages to be displayed and/or played to caller and/or callee etc.
Billing & accounting information
How to manage information (call logs) generated by this call?
Other features associated with the call

Some of these ‘tasks’ may be ‘required tasks’ while others may be optional. For instance, in some implementations the electronic address of the caller (IP address, on-line address and on-line routing information) is ‘required’ if the caller is on-line using his/her computer for this call. Similarly, the callee's phone number is also ‘required’ in some implementations. Alternatively, the caller may have clicked the link with an appropriate string to indicate that he/she wishes gNum system to arrange for a call between the caller's phone and callee's phone. In that case, gNum system may determine the caller's phone number and callee's phone number from <gnum_link>.

The gNum system may use a data-base to process <gnum_link> and determine the electronic addresses of the caller and the callee. One of the strings for the callee's electronic address may simply say ‘cocacola’ as the electronic address of the callee.

In that case, the gNum system will use a data-base to determine the phone number associated with the code-sequence ‘cocacola’. These code-sequences may be designed by the caller or callee. They may also be randomly generated and assigned to various callees in a way that the phone number of the callee is known only to the gNum system and not to a caller.

The gNum system may process <gnum_link> without requiring any information from the online accounts of the callee and/or the caller and/or the third party as <gnum_link> may be designed in a way to carry complete information about the call. It may also not be a requirement that either the callee and/or the caller and/or the third party have an on-line account with www.gnum.com (or equivalently some other account accessible to www.gnum.com). However, the gNum system may be able to provide further value-added services to the callers/callees/third party if they have such on-line accounts.

The gNum system may also require that the caller and/or callee and/or third party allow partial/complete access to his/her on-line account with www.gnum.com (or equivalently some other account accessible to www.gnum.com) for some of the tasks to be performed. The caller/callee/third party account access information may also be in one or more strings in <gnum_link> so that as the caller clicks the link, these accounts are accessible to gNum system to process the strings in <gNum_link>. For instance, the caller may click a link that requires that the gNum system access the caller's on-line account to determine the phone number of the callee from a string in <gNum_link>.

Similarly, the callee account may need to be accessed for some of the tasks to be performed and this information may also be placed in <gnum_link>. The callee may customize the links in numerous ways. The callee or someone else on his behalf may customize the <gnum_link> link for each caller (each friend or a group of friends) of the callee. Thus, different friends (or different groups of friends) will click a link having different <gnum_link> customized in a way that the gNum system will call the callee's phone number from a pre-determined gNum system phone number registered for each friend (or group of friends) by the callee or some other entity on his behalf. This gNum system phone number can then be used by the callee to determine the identity of the friend or the group of friends as the callee's phone is called by the gNum system. The callee phone number to be called can also be different for each friend or group of friends of the callee.

All the tasks/functions/features described above can be built into the <gnum_link> in a way that the caller and/or callee's on-line accounts may need to be or may not need not be accessed by gNum system for processing the link. They may not even have such accounts. In other instances, gNum system may process the link clicked by the caller to determine that it needs to identify the caller for the kind of call that gNum system needs to make for that link (for fraud detection & avoidance for instance). In such instances, the caller may be identified via his on-line account or be prompting him to enter a pre-assigned PIN or some other means. gNum system could ask caller to sign-in into his on-line account if he is not signed in before the gNum system will process the link further for making such a call. This may be crucial for billing as well as privacy and avoidance of frivolous calls and callers.

A significant aspect is that all the information for the call may be contained in the link and that in almost all instances the caller needs to do nothing more than clicking the link or entering it in the URL of the web-browser or scanning a QR code to make the call. gNum system determines the information related to the call, makes the call, and carries out all the other tasks/functions associated with the call before/during/after the call. Instances of such tasks include playing advertisements, checking for account and billing information for the caller and callee and if any of them does not have an account, then create one and inform them accordingly via on-line display for the caller and calling/SMS for the callee. Other tasks such as call recording, call-log etc. can also be provided. Billing and accounting information may also be provided in the <gnum_link>.

The web-link www.gnum.com/<gnum_link> can be created by either of the following entities
The caller, or
The callee, or
Third party other than the caller and callee, or
One and/or more of caller, callee, & third party in collaboration with each other.

The link may be created in a way that gNum system can process the link to establish who the creator of the link is. The gNum system may also provide for means to and assistance in creation of the link depending on the functions/tasks that the entity creating the link wishes to have for the call that will be made by the gNum system when the link is clicked. These links can be placed in the social networking web-sites, emails, blogs, etc. Depending on who the entity creating the <gnum_link> link is, the entity may be able to provide only for a limited set of functions/tasks depending on the information available to the entity and gNum system when the link is created.

It may be particularly advantageous that the URL is defined by the callee, the user of the recipient device 106. Thus, in such scenarios, the instance of <gnum_link> may be:

1. www.gnum.com/abcdefgh
or <gnum_link> = abcdefgh

To the gNum system, this may mean that the call is to be established between the caller's computer that was used by the caller to click the link to get to www.gnum.com and the callee's phone number identified by the string ‘abcdefgh’ in <gnum_link>. The gNum system now performs a data-base look-up to determine the callee's phone number corresponding to <gnum_link>=abcdefgh. Then gNum system makes the call between the caller's computer and the callee's phone number. Further, if the gNum system is able to determine the phone number of the caller then it may also call the callee in a way that the caller ID display of the callee's phone displays the phone number of the caller.

Thus, it will be appreciated that the communications server apparatus 102 of FIG. 1 is configured to receive the URL information relating to the caller input, the caller input comprising selection or activation of a URL defined by a recipient user of the recipient device.

Some other instances of <gnum_link> may be as follows:

2. www.gnum.com/+6596613446/+919990044055
or <gnum_link> = +6596613446/+919990044055.

To the gNum system, this may mean that the call is to be established between the phone numbers +6596613446 and +919990044055 where +6596613446 is callee's phone number and +919990044055 is another phone number (preferably caller's). The gNum system may also verify that +919990044055 is indeed a valid phone number by calling this phone number first. The caller may be provided a code and gNum system may prompt the caller to enter the code on-line in gNum system box. Alternatively, the caller may be prompted to sign into his on-line account or provide some other information that identifies him (a PIN for instance) and validates this phone number. When the phone numbers are verified, the gNum system then calls the two phone number and bridges the two calls. In other instances, the gNum system may simply proceed to call the two phone numbers to establish the phone call between them. In such cases the link may contain further strings to identify the caller/callee and that the calls to the two phone numbers must be made from specific gNum phone numbers.

3. www.gnum.com/abcdefgh/zzz/usa/estime_1100-1300
or <gnum_link> = abcdefgh/zzz/usa/estime_1100-1300.

To the gNum system, this may mean that the call is to be established between the callee's phone number identified by the string ‘abcdefgh’ and the caller's phone number identified by the string ‘zzz’ if the eastern standard time in USA is between 1100 hours and 1300 hours.

4. www.gnum.com/abcdefgh/zzz/+www
or <gnum_link> = abcdefgh/zzz//+www.

To the gNum system, this may mean that the call is to be established between the caller identified by the string ‘abcdefgh’ and the callee identified by the string ‘zzz’ and the callee must be called from the phone number identified by the string +www.

5. www.gnum.com/code_x/abcdefgh/zzz/+www/+xxx/5min
or <gnum_link> = code_x/abcdefgh/zzz/+www/+xxx/5min.

To the gNum system, this may mean that the caller will use the phone number identified by the string abcdefgh to call gNum system phone number identified by the string zzz within 5 minutes, and as that happens the gNum system should call the callee at phone number identified by the string +www from the gNum system phone number identified by the string +xxx and then bridge the two calls for the callee and caller to communicate with each other.

6. www.gnum.com/code_y/abcdefgh/zzz/usa
or <gnum_link> = code_y/abcdefgh/zzz/usa.

To the gNum system, this may mean that the callee is to be called at the phone number identified by the string abcdefgh, caller is on-line and the gNum system should call the callee from the gNum system phone number identified by the string zzz. The gNum system should make this call only if the caller is identified to be in the USA as per his IP address information determined by the gNum system when the caller's computer clicks the link to get to www.gnum.com.

7. www.gnum.com/code_z/abcdefgh/zzz
or <gnum_link> = code_z/abcdefgh/zzz.

To the gNum system, this may mean that the callee is to be called at the phone numbers identified by the string abcdefgh in a find-me-follow-me manner, caller is on-line and the gNum system should call the callee from the gNum system phone numbers identified by the string zzz. The gNum system should make these calls till the callee answers calls placed at one of the phone numbers called by corresponding gNum system phone number or all the phone numbers are exhausted. As a further function, the gNum system then may take a message (voice/video) from the caller if a call is not made.

Other tasks/feature/functionality rich and consequently more complex links can also be built for calling as will be clear to those skilled in the art. The invention and the accompanying embodiments described here provide for a feature/functionality rich calling experience to the callers and the callees based on one click calling. This invention provides for a true one click calling experience to the caller's in the sense that they click the link and then the gNum system does the rest of the tasks to complete the call and provide for all other functions/tasks associated with the call before/during/after the call.

A flowchart for the above method of making a call from a web-site to a phone is shown in FIG. 6.

The link www.gnum.com/<gnum_link> may also be used for the purposes of conference/group calling. Here, <gnum_link> contains one or more strings that are used by gNum system to determine that it is a conference call. Further, the gNum system processes <gnum_link> to determine the respective parties for the conference and their electronic addresses (phone numbers, IP addresses of their computers, etc.) for the call to be placed along with all the other tasks to be carried out before/during/after the conference/call. It then calls the electronic addresses of all the parties identified for the conference/call and bridges all the calls for the conference/group call to take place.

The gNum system may have other features built in whereby even if one or more of the callees are not available for the call, the gNum system proceeds to make the call connecting the rest of the caller and callees.

Thus, communication server apparatus 102 is configured to initiate a multi-party communication session between the calling device 104 the recipient device 106a and a third-party device (not illustrated). In such implementations, the URL may be defined by the user of one of the recipient devices 106a, 106b being called in the conference call.

For sending voice mail, the link/URL can be

www.gnum.com/vm/address

where the string ‘address’ identifies the callee and is either the phone number (or a string associated with one or more phone numbers) the voice mail is to be sent to and/or one or more email addresses the voice mail file is to be communicated to. After the caller clicks the link, the gNum system prompts the caller to use his voice to create the voice mail. Once done, the caller ends the voice mail. gNum system makes a recording of the voice message and delivers it to the callee(s) identified by ‘address’. The delivery can be done in many ways. A callee in ‘address’ can be invited via SMS/email/IM/social networking web-sites etc. to come on-line or make a call to retrieve the voice mail. Alternatively, a link can be created for the voice mail retrieval at www.gnum.com. This link can be sent to the callee and/or posted on social networking web-sites. Also the voice mail can be sent as a file attachment in an email to callees.

Other feature/functionality rich and consequently more complex links/URLs can also be built for voice mail in a manner similar to voice calling as will be clear to those skilled in the art.

For instance, voice to text transcription may be done and sent to callee(s) as an SMS. The invention and the accompanying embodiments described here provide for a feature/functionality rich voice mail experience using one click methods.

Thus, the recipient device may comprise a voicemail service for the recipient user, and the communications server is configured to initiate a communication session between the calling device and the voicemail service.

The <gnum_link> may contain information about whether the call is video and/or voice call. In the case of conference calling, the gNum system may process <gnum_link> or otherwise use on-line account info etc. to determine which of the caller and callees' devices (computer and/or phones) are capable of video/multi-media calling and which are not. Thus, gNum system may process <gnum_link> to determine the parameters of the call. gNum system then provides for a call that is purely video/multi-media call, or voice call or a mix of video/multimedia call (to one or more of those caller/callees with devices capable of handling such calls) and voice call (to others).

Further, gNum system may provide for numerous other functionalities such as link/URL creation for the calls, on-line account creation and management. Similarly, gNum system may provide for account creation. Such accounts may be linked to the phone numbers and/or email addresses and/or other on-line accounts of the callers/callees/third parties and verification may be done using emails, on-line accounts, voice calls and SMS.

FIG. 8 shows the gNum system (or part thereof) flow-chart for link/URL creation.

FIG. 5 shows a typical calls flow for FIG. 6.

FIG. 7 shows the typical flow of information/actions for FIG. 8.

It is also possible that the certain OS (iOS can be one instance of such OS) running on certain computers may not work with the calling method described here between the caller's computer and callee's phone due to OS settings. In such cases, a one-time download and configuration may be required for the caller's computer. We envisage such system configurations to be performed easily with the one-time software download provided for the caller's computer by gNum system.

Thus far, we have described a one-click method for calling (voice/video) between a caller and a callee initiated by the caller by simply clicking a link www.gnum.com/<gnum_link> or entering the corresponding URL in the web-browser. We now describe embodiments of the invention for other types of communication such as SMS, voice mail, fax etc.

For sending a SMS, the link/URL can be www.gnum.com/sms/phno/text_message where ‘phno’ is the phone number (or a string associated with one or more phone numbers and/or one or more email addresses) the text_message is to be sent to as SMS and/or email. The character string text_message is the content of SMS and/or email.

Other feature/functionality rich and consequently more complex links/URLs can also be built for SMS in a manner similar to voice calling as will be clear to those skilled in the art. It may even be a mix of SMS and emails that are sent out with one click by the caller. The invention and the accompanying embodiments described here provide for a feature/functionality rich SMS and email experience using one click methods.

For sending fax, the link/URL can be

www.gnum.com/fax/address1/address2

where ‘address1’ identifies the callee and is either his fax/phone number (or a string associated with one or more fax/phone numbers and/or email accounts) the fax is to be communicated to. Address2 is the address for the gNum system to retrieve the fax document from. It would typically correspond to a file on caller's computer and/or in a certain on-line acc. After the caller clicks the link, the gNum system accesses the file at address2 and creates a fax. Once done, the gNum system ends the fax. gNum system takes the fax and delivers it to the callee identified by ‘address1’. The delivery can be done in many ways. The callee at ‘address’ can be invited via SMS/email/IM/social networking web-sites etc. to come on-line or make a fax-call to retrieve the fax. Alternatively, a link can be created for the fax retrieval at www.gnum.com. This link can be sent to the callee and/or posted on social networking web-sites. Also the fax can be sent as a file attachment in an email to the callee.

Other feature/functionality rich and consequently more complex links/URLs can also be built for fax mail in a manner similar to voice calling as will be clear to those skilled in the art. The invention and the accompanying embodiments described here provide for a feature/functionality rich faxing experience using one click methods.

Thus far, we have described a system and the method for one click call from caller on a computer browsing the Internet to a callee on a phone number. We now describe a system and a method to provide for one click calling from caller to one or more callees (one to one or conference calling) when the caller and at least one of the callees are using the computer browsing the Internet. In this system and method, the caller clicks a link for a URL for making a call on a web-site, email, IM chat, blog, social networking web-site etc. Also the caller may enter the URL in the browser of his computer. Such a link is of the type

www.gnum.com/<gnum_link>, where

Here, <gnum_link> has the following format:

string1/string2/ . . . /stringn.

Each of the ‘n’ strings, string1, string2, stringn, is a string of alphanumeric characters. When the caller clicks the link (or equivalently enters the URL in the web browser of his computer),

www.gnum.com/<gnum_link>,

the caller's computer comes to the web-site www.gnum.com via the computer's web browser to make a call (video/voice) having service definition determined by the gNum system via <gnum_link> and other related information about the caller (IP address of caller's computer, the web-site the link was located when it was clicked) and so on. <gnum_link> may need to be decrypted by gNum system as it may be in encrypted form to protect callers, callees and the overall gNum system. The gNum system also determines the web-site the caller was on (if any) when he/she clicked the link and the IP address of the caller's computer when he/she comes to the web-site www.gnum.com by either entering the URL in the browser of his computer or by clicking the link.

The <gnum_link> may contain information about whether the call is video and/or voice call. In the case of conference calling, the gNum system may process <gnum_link> or otherwise use on-line account information etc. to determine which of the caller and callees' devices (computer and/or phones) are capable of video/multi-media calling and which are not. Thus, gNum system may process <gnum_link> to determine the parameters of the call. gNum system then provides for a call that is purely video/multi-media call, or voice call or a mix of video/multimedia call (to one or more of those callees with devices capable of handling such calls) and voice call (to others).

It will be clear to those skilled in the art that most of the previous description of the one click system and method for making a call between the caller on his computer and the callee on his phone number is also applicable in the current situation for making a call between the caller on his computer and at least one of the callees on his computer as well. Hence, we will now describe only those aspects which may not be directly obvious from previous descriptions.

The <gnum_link> can again be created and customized by either the caller and/or a callee and/or a third party working on their own or in some collaboration.

When the caller clicks the link www.gnum.com/<gnum_link> to get to the gNum system, gNum system processes <gnum_link> to determine electronic addresses of the callees. Some of these callees will have phone numbers, others will have on-line addresses (for example, Skype ID xxyyzz, or email address xyz@abc.com, or gNum ID zzyyxx, or Facebook ID abc). If the callees with the on-line addresses are signed into their on-line accounts with www.gnum.com, then gNum system knows the addressing information (IP addresses etc.) for establishing the call (video/voice or a mixture of the two) to such callees' computers.

Similarly, the callees may be signed into their on-line account with a collaborating web-site and/or another web-site that can be used by gNum system to determine callees' identity and address/routing information (IP addresses etc.) required for the communication link for the call.

The gNum system may use the caller's on-line social networking accounts to facilitate the entire process. For example, gNum system may post a request and/or an IM to a callee's Facebook account on behalf of the caller using caller's Facebook account. gNum system may send a request to a callee who is a friend or family on Facebook on behalf of the caller using his Facebook account as per the settings of the Facebook accounts of the caller and the callee. Also the caller and the callee may set up their social networking accounts (say Facebook) whereby gNum system can use the caller's Facebook account to determine if the callee is online and what his addressing/routing info (IP addresses etc.) is for the data communication required for the call. This could also be done for other type of accounts such as Skype (Google, MSN, Yahoo) accounts if both the caller and callee have such accounts. gNum system may even go thru the other on-going activities on the caller's computer (other websites including social-networking ones being browsed, ongoing VoIP and IM sessions, games, peer-to-peer file sharing/download, automatic log-ins into accounts with Skype, MSN etc.) to determine the callee's on-line addressing information required for the call. The gNum system may also send an invite to the callee(s) on behalf of the caller via the callee(s) email, IM, gaming/peer-to-peer sites, blog posts, chats, Facebook postings. Such an invite from the gNum system may also contain a link for the callee to click (one click call-back for the callee) so that he is now able to call back to have a call with the caller's computer visiting the website www.gnum.com. The link may also contain information about the caller that that callee may use to identify the caller. Thus in this case, no software download and/or system configuration is required for the callee's computer for the call to be made.

The gNum system may use all the other addressing information that the caller has (email addresses, IM, Facebook, etc.) about the callees to send invites to provide for the information required to connect the call to the callees. The gNum system may also go thru the caller's on-line accounts (search thru VoIP calls, recent chats, emails, IM logs etc. between caller and callees) to determine the addressing information for the callees that is required for the gNum system to connect to them to make the call. Once the gNum system has the addressing information and TFF (tasks, features, functions) for the call are determined, the gNum system make a call to the callees and establishes the call. The gNum system may have other features built in whereby even if one or more of the callees are not available for the call, the gNum system proceeds to make the call connecting the rest of the caller and callees.

In another embodiment, an instance of a link for a one-click computer to computer call is as follows www.gnum.com/callee@abc1.com/callee@abc2.com/caller/caller_ID_info

When the caller clicks the link, the caller's computer comes to the web-site www.gnum.com and the gNum system identifies the caller via the string caller_ID_info and creates a link

www.gnum.com/caller_ID_info/callee@abc1.com/callee@abc2.com

and sends it in an email to the callee at callee@abc1.com and callee@abc2.com. In other instances, the link could be sent to the callee via IM, SMS, Facebook postings, blogs etc. When the callee clicks the link in either of the two emails, callee's computer comes to www.gnum.com and the gNum system identifies the caller via caller ID info and then establishes a call between the caller and the callee.

FIG. 12 shows a flow-chart for the above method of making a call from the caller's computer to the callee's computer.

We again reassert that the caller did not have to download any software or configure his computer to make the call. The call was made by the caller using the web-browser and by clicking on a link (on a web-page or in an email, IM chat etc.) or by entering the URL into the web-browser.

We now describe two techniques that can be used to provide for one click calling to the caller using the Internet browser on his computer (no software download etc. required) while the callees have downloaded a software application and configured their computers accordingly.

The first is an embodiment for VoIP providers that require the callers and callees to download a software application and configure their computers to use it for making video and/or voice calls to others who have also downloaded the software. The callers and the callees may also have to give prior permission to call each other. Let us say that one such provider is Skypei. Now consider that a callee has a Skypei account with Skypei ID abc and a caller wishes to make a one click call to that callee. In this case, the caller can click on a link for the URL

www.skypei.com/abc

or enter the URL in the browser of his computer. The caller will come to the Skypei web-site

www.skypei.com

and indicate to Skypei server that the caller wishes to make a call to the callee with Skypei ID abc. The Skypei server knows the routing and on-line addressing information for the callee (thru Skypei software running on his computer) and the caller browsing Skypei web-site. Therefore it now establishes a call between the caller and the callee.

In yet another embodiment, the link can be for the URL

www.skypei.com/abc/def

where def is the Skypei ID of the caller. Now when the link is clicked by the caller, the Skypei server knows the caller and callee Skypei ID (strings def and abc correspond to these Skypei IDs and caller Skypei account identification/signing information, respectively) and therefore it calls the callee from caller's Skypei account. Again, the call is established between the caller's computer (no Skypei software download required for the caller's computer) and the callee's computer with Skypei software downloaded/configured. Skypei server may also require that the caller sign in his on-line account with Skypei before it will make the call. The sign in info may even be a part of the link that the caller clicks to make the call and no additional steps may be required on the part of the caller. The on-line Skypei account of the caller may also contain information about which of the Skypei IDs the callers can communicate with based on various permissions and availability of the callees. In another embodiment, the caller may sign into his on-line account with www.skypei.com and then the Skypei server may present to the caller via his account the links to click (or some other equivalent method) for the various callees.

FIG. 9 shows a flow-chart for such a system and method to make a computer to computer call using the above method.

It is also possible that an independent third party, say gNum system at www.gnum.com, may provide for calling between two Skypei account holders while requiring no download for the caller's computer. In that case the link for the caller to click can have the URL

www.gnum.com/caller_gnum_ID/caller_Skypei_ID/callee_Skypei_ID

When the caller clicks the link, the caller's computer comes to www.gnum.com. The gNum system recognizes this as a request by the caller identified by caller_gnum_ID to make a call between caller's Skypei ID caller_Skypei_ID and callee's Skypei ID callee_Skypei_ID. The gNum system may perform the following tasks:

1. Run an instance of Skypei software on gNum server and log into the caller's Skypei account using the Skypei ID caller_Skypei_ID.

2. Call the Skypei ID callee_Skypei_ID from the Skypei account caller_Skypei_ID.

3. As the call is made, connect the caller at www.gnum.com to the call between the Skypei ID caller_Skypei_ID and callee_Skypei_ID. Such a call can also utilize peer to-peer methods for communication of data required for the call. Further the gNum system may have to change the codec and data formats required for the data communication between the caller's computer and gNum system and the Skypei call between Skypei ID caller_Skypei_ID and callee_Skypei_ID.

4. As the call is completed, the gNum system signs out of the caller's Skypei account caller_Skypei_ID.

FIG. 10 shows a flow-chart for such a system and method to make a computer to computer call using the above method.

In yet another technique, the caller and callee may have downloaded Skypei software on his computer and configured it accordingly. When a caller wants to make a call to the callee, he uses his Skypei application running on his computer to click the callee's name to initiate the call. However, the caller may not be able to make the call as the callee may not be available on his computer to receive the call on the Skypei application running on callee's computer. In such a case, the Skypei server may create a link for the callee to click and send such a link to him via email, IM, posting on Facebook page of callee etc. The callee may now click on the link if he wishes to when he sees it in his emails, IM, Facebook (any other social networking web-sites), blog etc. As he clicks the link, the callee now comes to www.skypei.com and the Skypei server recognizes that this is meant for a call between the caller and the callee and proceeds to establish the call between the two.

FIG. 11 shows a flow-chart for such a system and method to make a computer to computer call using the above method.

It will be appreciated that though the systems and methods described herein may correspond to one-click calling (one step calling), the concept may also be implemented via more than one step as will be evident to the skilled person. All such techniques whether implemented via one click (step) system and method or more than one click (step) system and method are also included in the scope of the techniques described here.

As mentioned above, the URL may be activated in a number of ways. For instance, and as also mentioned above, one method is to select a hyperlink pointing at a web resource defined by the URL. Another is to enter the URL in the address bar of a web browser and pressing “ENTER” to activate the URL. This may result in the relevant gnum webpage loading in a web browser of the calling device. Note, also, that depending on the specific application and depending on, say, the particular hardware configuration of the calling device, it may be preferable that the activation of the hyperlink causes a separate software application—separate from the web browser—to be called responsive to the URL being selected/activated. Depending on the precise configuration, the software application may be launched before or after the web browser, or launched as an alternative to the web browser. Such arrangements may be particularly advantageous in smart phones, PDAs and tablet devices.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1. Communications server apparatus comprising a processor and a memory, the communications server apparatus being configured, under control of the processor, to execute instructions stored in the memory:
to receive, over a communications link, URL information relating to a caller input at a calling device, the caller input being selection or activation of a URL as a request for a communication session with a recipient device;
to identify the recipient device using the URL information; and
to initiate the communication session between the calling device and the recipient device.

2. The communications server apparatus of claim 1 configured to receive the URL information relating to the caller input, the caller input comprising selection or activation of a URL defined by a recipient user of the recipient device

3. The communications server apparatus of claim 1 or claim 2 configured, responsive to receipt of the URL information, to transmit webpage information to the calling device, the webpage information comprising application code for an application for channeling the communication session between the calling device and the recipient device.

4. The communications server apparatus of claim 3 configured to transmit, to the calling device, application code for the application to run in the background of a web browser program on the calling device.

5. The communications server apparatus of claim 3 or claim 4 configured to transmit, to the calling device, application code for causing the calling device to transmit an initiate call request to the communications server apparatus, the initiate call request being a request to initiate a call to the recipient device.

6. The communications server apparatus of claim 5, wherein the communications server apparatus is configured, responsive to receiving the initiate call request, to retrieve a call identifier for the recipient device using the URL information, and to initiate a call to the recipient device using the call identifier.

7. The communications server apparatus of any preceding claim, wherein the communications server is configured to channel the communication session between the calling device and the recipient device on the basis only of selection or activation of the URL at the calling device.

8. The communications server apparatus of any preceding claim, wherein the recipient device comprises a voicemail service for the recipient user, and the communications server is configured to initiate a communication session between the calling device and the voicemail service.

9. The communications server apparatus of any preceding claim, wherein the communications server is configured to initiate a multi-party communication session between the calling device, the recipient device and a third-party device.

10. A calling device comprising a processor and a memory, the calling device being configured, under control of the processor, to execute instructions stored in the memory:
to receive a caller input, the caller input being selection or activation of a URL as a request for a communication session with the recipient device;
to transmit, over a communications link, URL information relating to the caller input to a communications server apparatus, for allowing the communications server apparatus to identify the recipient device using the URL information; and
to communicate, over the communications link, with the recipient device responsive to the communications session being initiated by the communications server apparatus.

11. The calling device of claim 10, configured to receive the caller input as selection or activation of a URL defined by a recipient user of the recipient device.

12. The calling device of claim 10 or claim 11 configured to receive, from the communications server apparatus, webpage information comprising application code for an application for channeling the communication session between the calling device and the recipient device.

13. The calling device of claim 12 configured to receive application code from the communications server apparatus for the application to run in the background of a web browser program on the calling device.

14. A method, performed in a communications server apparatus, the method comprising, under control of a processor of the communications server apparatus:
receiving, over a communications link, URL information relating to a caller input at a calling device, the caller input being selection or activation of a URL as a request for a communication session with a recipient device;
identifying the recipient device using the URL information; and
initiating the communication session between the calling device and the recipient device.

15. A method, performed in a calling device, the method comprising, under control of a processor of the cotton device:
receiving a caller input, the caller input being selection or activation of a URL as a request for a communication session with the recipient device;
transmitting, over a communications link, URL information relating to the caller input to a communications server apparatus, for allowing the communications server apparatus to identify the recipient device using the URL information; and
communicating, over the communications link, with the recipient device responsive to the communications session being initiated by the communications server apparatus.

16. A computer readable medium having stored thereon computer-readable instructions for executing, under control of the processing device, the method of claim 14 or claim 15.
